(19) United States
(12) Patent Application Publication
(10) Pub. No.: US 2003/0093345 A1
(43) Pub. Date: May 15, 2003

(54) Fund for wind energy projects and a method for establishing the same

(76) Inventor: Michael D. Cutbirth, Santa Barbara, CA (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/037,910

(22) Filed: Nov. 9, 2001

(51) Int. Cl. G06F 17/60

(52) U.S. Cl. 705/35

(57) ABSTRACT

A fund established for the purpose of investing in multiple U.S. wind energy projects. The fund is capitalized with an initial equity investment by a group of investors that includes additional equity investment over the tax-advantaged years of the projects. The fund is also capitalized with third party dual tranche financing that provides for amortization of the debt from both the cash flow generated by the projects and the additional capital contributions from the investors.

### BACKGROUND OF THE INVENTION

The invention disclosed herein relates generally to a fund and a method for establishing the same, and more particularly to a business entity that is treated as a partnership for tax purposes and invests in a plurality of wind energy projects and a method for establishing and investing in the business entity.

The U.S. wind energy industry evolved in the wake of the world oil crises of 1973-74 and 1978-79 in part due to efforts on both the state level and the federal level. The passage of the Public Utility Regulatory Policy Act (PURPA) in 1978 created a market for wind generated power where previously none had existed. Other legislation put valuable incentives in place to further fuel the growth of the industry. The incentives were crucial to the evolution of the industry, since incentives increase the returns from an investment that otherwise generates a low rate of return if any.

Since United States wind energy projects are generally unattractive as stand-alone investment opportunities because they do not generate a reasonable rate of return, government incentives in the form of tax credits are necessary to encourage private investment. For this reason, the projects are considered “tax-advantaged investments” and are therefore tax driven investments. As such, in order to realize the full economic return from such investments, investors must have a significant taxable income and therefore significant tax liabilities, which may be reduced or offset by the tax benefits.

A tax-advantaged investment refers to a type of investment program or vehicle that reduces the impact of taxes on investor earnings. The name “tax-advantaged” generally refers to three different kinds of investments: tax-deferred, tax-free and tax-reducing. Tax-deferred investments simply defer taxes until investment earnings are withdrawn, at which time the investor is more likely to be in a lower tax bracket. Tax-free investments produce earnings that are actually free from federal taxes, and sometimes free from both federal and state taxes. Tax-reducing investments reduce the amount of federal taxes, but do not necessarily eliminate taxes altogether.

Some tax-advantaged investments produce “tax credits” that are used to alleviate federal taxes associated with income. These tax credits may be implemented as one-time benefits associated with the level of investment, or as tax credits that accrue over time in proportion to the incentivized activity. Wind energy projects may generate a production tax credit of the latter class in that the level of tax credits produced is based on the amount of electricity generated by the project.

The cost of producing electricity from wind-driven turbines or windmills has declined substantially over the last twenty years but is widely recognized as more costly than producing electricity using lower cost fossil fuel, e.g. coal, oil and natural gas. Because of the higher cost, electric generating companies and other developers would not be planning and building wind farms if it were not for subsidies and other incentives. Each of these incentives has the effect of shifting costs—principally from the wind farm owner or developer to taxpayers, electric customers or the government.

Under current tax law, windmill owners can use five-year double declining-balance, accelerated depreciation for federal income tax purposes. For organizations with income to shelter from federal taxes, the practical effect of this tax benefit is to permit “recovering” 52% of the capital investment during the first 18 to 24 months after the project becomes operational. The remaining 48% is recovered in the ensuing 36 to 48 months. These percentages may change in some instances such as for short tax years where the mid-quarter convention is used. Some states provide similar benefits that shelter income from state income taxes.

Wind energy developers also have an incentive to bring renewable generating capacity on line so that they will qualify for a dollar amount per kWh production tax credit that is available for the first 10 years of each windmill's life. The production tax credit is in addition to the federal tax shelter benefits resulting from the availability for windmills of five-year double declining-balance, accelerated depreciation for federal tax purposes.

The nature and amount of the various tax incentives is a recurring federal tax issue that is frequently reviewed by the federal government. This creates uncertainty for investors that, in turn, makes wind energy investments less attractive. Moreover, even when the incentive scheme is constant, investments must be timed so that the incentives apply to a given tax year, and production-based tax credits require that the wind energy project come on line and begin producing on schedule. These factors burden investors by requiring constant attention to legislation, timing of investments, and operation of the individual investments. These sources of uncertainty combine to make a wind-energy investment less attractive than other alternatives. A need exists for a system and method that will insulate investors to some degree from these uncertainties that are inherent in single-project investments.

Typically, U.S. wind energy projects are financed on a “one-off” basis. Specifically, owners and investors in wind projects usually secure some third party non-recourse debt financing and then make a capital investment on a project-by-project basis. However, “one-off” financing substantially increases the amount of risk for investors since there is only a single project. All risks associated with that project such as fluctuations in the wind, inclement weather and other force majeure type events, equipment failure, management difficulties, higher than expected maintenance costs, and the like will be borne by the investors in that project. Not only does this create a less attractive investment, but also discourages investment in innovative projects, locations and technologies which may increase the real or apparent risk of a given project.

In addition, since U.S. wind energy projects do not generate an attractive return on investment for the average investor, the pool of investors is quite small. Most investors simply do not have either the ability to utilize the tax benefits and/or expertise or the appropriate information regarding the associated risks and benefits. Moreover, there is an abundance of other opportunities that do not require such ability to utilize tax benefits and expertise. As a result, investors do not devote the time or hire the personnel to seek out information about the wind energy industry.

It is therefore desirable to establish a fund that pools capital from a range of investors seeking to reduce the risk associated with investing in individual tax-advantaged investment opportunities. More particularly, there is a need for a fund that enables investing in a multitude of tax-advantaged wind energy projects, thereby providing a return to the investors as well as mitigating and allocating the associated risks across multiple investors and several projects. Further still, a need exists for an investment vehicle that lessens the need for intimate knowledge by investors of complex industries such as wind-energy production while providing predictable risk/reward performance and enabling investors to take advantage of tax benefits provided by investments in those industries.

### SUMMARY OF THE INVENTION

Particularly disclosed herein is a tax-advantaged investment fund. The fund will have an ownership interest in a plurality of wind energy projects having a return comprising a cash flow distributions, accelerated depreciation deductions and a plurality of tax credits in addition to the residual value of the projects. The fund also has a plurality of investors that provide capital for investing in the ownership interest in the plurality of wind energy projects. A portion of the capital structure of the fund comprises a debt component that may or may not have a single or a dual tranche structure. Bank and institutional lenders may provide the debt component of the fund. The plurality of investors each receive a portion of the return by virtue of the partnership treatment of the fund and “pass through” of cash flow and tax benefits from the fund to the individual members.

In another aspect, the present invention provides a method for creating a tax-advantaged investment fund. The tax-advantaged investment fund has a plurality of investors comprising a plurality of equity members. The fund secures debt from one or more lenders to the fund. A portion of the capital of the fund is equity collected from the plurality of investors, and a portion of the capital of the fund is debt from the at least one lender. The debt component may have a single or a dual tranche structure. The capital is used to purchase a plurality of wind energy projects having a return comprising a cash flow distribution, accelerated depreciation deduction and tax credits and the residual value of the projects.

In yet another aspect, the present invention provides a method for managing a tax-advantaged investment fund. The tax-advantaged investment fund is established having a plurality of investors comprising a plurality of equity members. Debt is secured from one or more banks or institutional lenders. A portion of the capital of the fund is equity invested by the plurality of investors, and a portion of the capital of the fund is a debt component having either a single or a dual tranche structure. The identity of a plurality of wind energy projects to purchase is determined. The equity capital is invested by the fund by wholly owned business entities in portions. The fund uses the equity contributed by each member of the fund to purchase at least one wind energy project having a return comprising a cash flow distribution, an accelerated depreciation deduction, a plurality of tax credits, and residual value of the projects.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawing, wherein:

The sole figure is a block diagram of the structure of the fund in accordance with the present invention.

### DESCRIPTION OF A PREFERRED EMBODIMENT

In general, the present invention is directed to a fund and methods for operating and managing that fund that encourage investment in wind energy projects. As used herein, a “fund” refers to a pool of money or other resources, usually supplied by plurality of investors, whose principle and/or interest is set aside for a specific objective (e.g., investment in wind energy projects). In the specific examples herein, the fund is structured to pass through tax incentives to the plurality of investors. The plurality of investors typically comprise large U.S. corporations with large taxable income.

The fund in accordance with the present invention is structured so as to modify the risk/reward balance associated with any particular project in a manner that makes an investment in a wind energy project more attractive to a larger number of investors. By increasing the size of the pool of investors, longstanding government goals of developing alternative energy production are furthered, while at the same time creating jobs and efficiently applying capital from private investors.

The sole figure illustrates an overview of an exemplary structure of an investment fund for investing in a plurality of U.S. wind energy projects according to an example embodiment of the present invention. As illustrated, a fund 100 is established in which one or more investors 110, 120 invest or provide capital to finance the acquisition of one or more of wind energy projects such as projects 170, 180 and 190. Lender 130 may provide debt financing directly to fund 100 or may provide debt on a project-by-project basis directly to projects or the entity in which the project exists, such as illustrated with project 190 and entity 140.

Fund 100 is illustrated in the figure as a limited liability company. Fund 100 may be established as any type of business organization or entity type created for the purposes of investing in multiple projects, including but in no way limited to a limited liability company (LLC), a limited liability partnership (LLP), a trust or any other organization that limits investor liability while providing a pass through of certain tax benefits such as any entity subject to taxation under Subchapter K of the Internal Revenue Code of 1986 as amended.

Fund 100 may be capitalized by both an equity investment and third party debt financing. In the illustrated example, the equity investment is provided by class A managing members 110 and class B investing members 120 and the third party debt financing is provided by lender 130. A typical ratio of the total debt to total equity ranges from approximately 40-60% debt and 60-40% equity. However, one skilled in the art can appreciate that the debt to total equity ratio varies with respect to the appropriate levels of financing needed or that can be supported for a particular project.

Class A managing members 110 provide the “sweat equity” to fund 100. In the illustrated embodiment, managing members 110 are responsible for establishing the fund or fund formation. Fund formation includes determining the type of business organization, determining the controlling law of the business organization, determining the identity of officers, establishing the guidelines that the fund operates under, structuring and securing debt financing structuring and establishing the structure of the fund and arranging for the appropriate action to take upon dissolution of the fund to name a few. Once the fund is established, class A managing members 110 market the fund to suitable class B investing members 120.

Class A managing members 110 are also responsible for identifying the appropriate investment projects and entering into agreements to acquire the specific wind projects. In this manner, managing members 110 provide expertise, skill and experience in wind energy industries, the lack of which have heretofore presented barriers to investment in such industries. While there is significant latitude in the selection of appropriate projects, some criteria include projects that preferably can be funded entirely by capital of fund 100, projects having suitable projected production, for example. One advantage of the present invention is that when fund 100 invests in a plurality of projects, the risk/reward functions of the various projects can be pooled. Hence, fund 100 is able to invest in somewhat riskier projects by balancing the portfolio of fund 100 with less risky projects. Moreover, fund 100 may select projects geographically to mitigate risks associated with regional power markets and regional fluctuations in the wind.

Once an investment project is found, managing members 110 direct the capital resources of the fund to acquire the various projects. Since managing members 110 are responsible for the day-to-day operation of the fund, they may not be required to provide a monetary contribution to fund 100. In a particular example, class A managing members may provide 1% of the equity capital to fund 100.

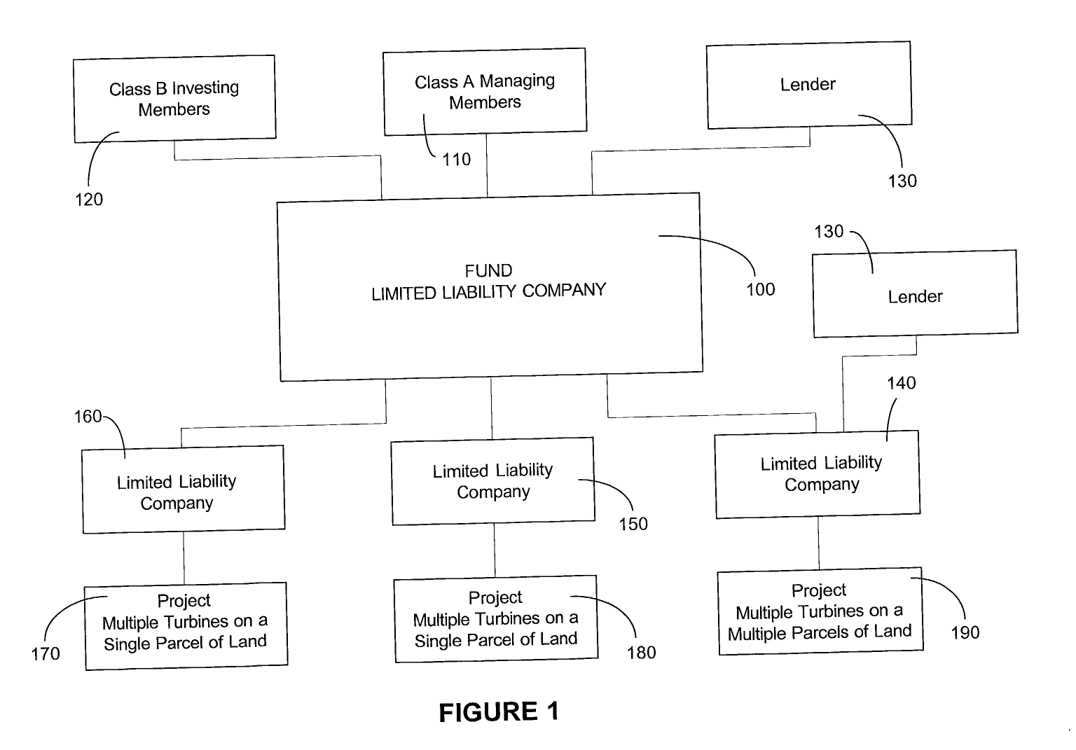

Class B investing members 120 provide at least a portion of the working capital to fund 100. Class B members 120 invest almost the entire amount of the equity in fund 100. In the example of FIG. 1, class B members are responsible for 99% of the equity contribution. Since projects 170, 180 and 190 do not offer an attractive rate of return without incentives, Class B members 120 are typically corporations with high taxable income and therefore high tax liabilities. Class B investing members 120 may buy and sell their interest in fund 100 with or without restrictions imposed by the fund structure and/or government regulatory authorities. In practice, limitations on trading may be imposed to ensure that fund 100 is able to be treated as a passthrough entity for tax purposes rather than a corporation. In preferred implementations both the number and characteristics of class B members 120 are selected such that ownership interests are sold by private offering or a security sale under SEC rule §144(a).

During years where any of the projects 170, 180 and 190 produce electricity, they generate tax credits in proportion to their production. During a statutorily defined period of those productive years, the projects generate tax benefits such as investment tax credits and production tax credits. During the tax-advantaged years of fund 100, class B investing members receive a large share of the distribution of incentives and cash flow from projects 170, 180 and 190.

Lender 130, which may be a single lender, multiple lenders, banks or institutional lenders, provides optional debt financing to fund 100. In addition, lender 130 may provide debt financing directly to individual projects. The debt financing received from lender 130 may have a single or a dual tranche structure. A first portion of the debt financing may be amortized over a fixed number of years, such as 15 or 20 years, based on the cash flow generated from the projects owned by the fund. The second portion of the debt financing may be amortized over the period the project generates tax credits, such as a 10 year production tax credit period. The second portion is preferably paid off over the production tax credit period using additional capital contributions made by the Class B investors in fund 100.

In the illustrated example, fund 100 provides capital to a plurality of limited liability companies 140, 150 and 160. Each limited liability company in turn invests capital in a project at the direction of fund 100. For example, fund 100 provides capital to limited liability company 160, which then purchases project 170. The fund is preferably a one hundred percent owner in limited liability company 160 and therefore indirectly owns one hundred percent of project 170.

Projects 170, 180 and 190 are illustrated in the figure as U.S. wind energy projects having multiple turbines on a single or multiple parcels of land. In 1992, the Energy Policy Act was signed into law and included enactment of a Production Tax Credit (PTC) under Section 45 of the Internal Revenue Code of 1986. This credit was available to corporate entities building new renewable energy production facilities such as closed-loop biomass, and wind electric power production plants. The tax credit at inception of the law was $0.015 per kilowatt hour (kWh) produced by the facility, increased each year by the official rate of inflation from the previous year, for the first ten years of operation of the equipment.

Projects 170, 180 and 190 each generate a return. Since fund 100 owns a one hundred percent interest in each individual project, the return is the sole property of the fund, whether the fund owns the projects directly or indirectly. The return from each project 170, 180 and 190 comprises a plurality of production tax credits, accelerated depreciation, a cash flow distribution as well as residual value of the projects. The return is dispersed to the investors (the providers of capital) in accordance with a sharing ratio. The sharing ratio is contractually defined and may change over time.

Class A members 110 and class B members 120 share in the return from each wind energy project according to the sharing ratio. The sharing ratio is not necessarily related to the amount of capital contributed by either group of members to fund 100. In one example, in the tax-advantaged years of fund 100, class B investing members 120 receive 99% of the return and class A managing members 110 receive 1% of the return. At the end of the tax-advantaged years of the project, for example, class B investing members 120 may receive 40% of the return and class A managing members 110 receive 60% of the return for years eleven through fifteen and class B investing members 120 may receive 30% of the return and class A managing members 110 receive 70% of the return for ears sixteen through twenty.

In this manner, tax incentives generated by investments made by fund 100 are allocated to the class B members 120, to whom the tax incentives have the greatest value. Fund 100 may sell its interest in particular projects after the tax-advantaged period and repay any outstanding debt financing, or fund 100 may continue to hold the interest until the repayment of debt financing, or fund 100 may continue to hold the interest through the life of the project. Once the tax credit period is over, the project value becomes proportional to the energy production. However, the initial capital investment having been made, the wind energy project may go forward in a cost efficient manner.

While there have been described above the principles of the present invention in conjunction with a specific embodiment, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein.

Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

What is claimed is:

1. A tax-advantaged investment fund comprising:
an ownership interest in a plurality of wind energy projects having a return comprising a cash flow distribution, an accelerated depreciation deduction, a plurality of tax credits, and a residual value of the projects; and
capital for investing in said ownership interest in the plurality of wind energy projects, wherein a first portion of said capital comprises debt from at least one lender and a second portion of said capital comprises equity from a plurality of investors, wherein said plurality of investors each receive a portion of the return.

2. The tax-advantaged investment fund of claim 1, wherein the plurality of investors comprise a plurality of equity members that receive a portion of the return in accordance with a sharing ratio for a tax-advantaged period of the fund.

3. The tax-advantaged investment fund of claim 2, wherein said tax-advantaged period comprises a period of time provided by a statute for the provision of the plurality of tax credits.

4. The tax-advantaged investment fund of claim 2, wherein said sharing ratio comprises distribution for the tax-advantaged period of the fund in proportion to each equity member's respective capital contribution.

5. The tax-advantaged investment fund of claim 1, wherein the at least one lender receives repayment based on a dual tranche structure.

6. The investment fund of claim 5 wherein said dual tranche structure comprises:
a first portion of the debt having a first amortization period of a fixed number of years based on the cash flow of the plurality of wind energy projects; and
a second portion of the debt having a second amortization period based in part upon the timing of the capital that is contributed from the plurality of investors.

7. The tax-advantaged investment fund of claim 1, wherein said at least one lender is repaid from a portion of the cash flow from the plurality of wind energy projects and/or the capital of the tax-advantaged investment fund.

8. The tax-advantaged investment fund of claim 1 comprising a plurality of business entities, each business entity having an ownership interest in at least one of the plurality of wind energy projects, wherein the fund has an ownership interest in the plurality of business entities but not directly in the plurality of wind energy projects.

9. The investment fund of claim 8 wherein said ownership interest in the plurality of business entities comprises a 100% ownership interest.

10. The investment fund of claim 8 wherein said plurality of business entities comprise business forms that enable pass-through tax treatment.

11. The investment fund of claim 1 wherein said tax-advantaged investment fund comprises a business form that enables pass-through tax treatment.

12. The investment fund of claim 1 wherein said ownership interest in a plurality of wind energy projects comprises a 100% ownership interest.

13. The investment fund of claim 1 wherein said plurality of investors comprise:
a plurality of investing members that provide a first portion of the capital, wherein said investing members receive a first shared portion of the return for the tax-advantaged years of the find; and
at least one managing member that provides a second portion of the capital, wherein said at least one managing member administers the fund and receives a second shared portion of the return for the tax-advantaged years of the fund.

14. The investment fund of claim 1, wherein said wind energy projects qualify for a generation of a plurality of Production Tax Credits in accordance with Subchapter 45 of the Internal Revenue Code of 1986 as amended, or any successor statute thereto.

15. The tax-advantaged investment fund of claim 1, wherein said plurality of wind energy projects is geographically diverse.

16. A tax-advantaged investment fund comprising:
an ownership interest in a plurality of wind energy projects having a return comprising a cash flow distribution, an accelerated depreciation deduction, a plurality of tax credits, and residual value of the wind energy projects;
equity capital for investing in said ownership interest in a plurality of business entities comprising:
a plurality of investing members that provide a first portion of the equity capital, wherein said investing members receive a portion of the return in accordance with a first sharing ratio for a tax-advantaged period of the fund; and
at least one managing member that provides a second portion of the equity capital, wherein said at least one managing member administers the fund and receives a portion of the return in accordance with a second sharing ratio for the tax-advantaged period of the fund; and
at least one lender that provides a debt component either directly to the fund and/or one of the plurality of wind projects directly and receives a distribution from a portion of the cash flow from said wind energy projects and/or said fund.

17. The tax-advantaged investment fund of claim 16, wherein said at least one lender receives repayment based on a dual tranche structure.

18. The tax-advantaged investment fund of claim 16, wherein said dual tranche structure comprises:
a first portion of the debt having a first amortization period of a fixed number of years based on the cash flow of the plurality of wind energy projects; and
a second portion of the debt having a second amortization period based in part upon the timing of the equity capital that is contributed from the plurality of investors.

19. A method for creating a tax-advantaged investment fund comprising:
forming an entity having a business form that enables the entity to passthrough tax benefits;
establishing the tax-advantaged investment fund having a plurality of investors comprising a plurality of equity members;
collecting capital from the plurality of investors; and
using the capital to purchase a plurality of wind energy projects having a return comprising a cash flow distribution, accelerated depreciation deduction and tax credits.

20. The method of claim 19 further comprising:
collecting a debt component from at least one lender; and
providing said debt component to said tax-advantaged investment fund to purchase a plurality of wind energy projects.

21. The method of claim 19 further comprising:
collecting a debt component from at least one lender; and
providing said debt component directly to one of a plurality of wind energy projects.

22. The method of claim 21, wherein said debt component comprises a dual tranche debt structure comprising:
a first portion of debt having a first amortization period of a fixed number of years based on the cash flow of the plurality of wind energy projects; and
a second portion of debt having a second amortization period based in part upon the timing of the capital that is contributed from the plurality of investors.

23. The method of claim 22 further comprising the act of repaying the debt component from cash flow generated by the plurality of wind energy projects and/or the capital of the fund.

24. The method of claim 19 further comprising providing the equity members a portion of the return in accordance with a sharing ratio for a tax-advantaged period of the fund.

25. The method of claim 19 further comprising an act of providing the capital to a plurality of wholly owned business entities in portions, wherein the wholly owned business entities perform the act of using the capital to purchase a plurality of wind energy projects.

26. A method for managing a tax-advantaged investment fund comprising:
establishing the tax-advantaged investment fund having a plurality of investors comprising a plurality of equity members;
collecting capital from the plurality of investors;
collecting a debt component from at least one lender;
determining the identity of a plurality of wind energy projects to purchase;
providing the capital and debt to the plurality of wind energy projects having a return comprising a cash flow distribution, an accelerated depreciation deduction and a plurality of tax credits.

27. The method of claim 26 further comprising providing the equity members a portion of the return in accordance with a sharing ratio for a tax-advantaged period of the fund.

28. The method of claim 26 comprising repaying the debt component from cash flow generated by the plurality of wind energy projects and/or the capital of the fund based on a dual tranche structure.

29. A method for investing in a tax-advantaged investment fund comprising:
providing capital to the tax-advantaged investment fund for investing in a plurality of wind energy projects having a return comprising a cash flow distribution, an accelerated depreciation deduction and a plurality of tax credits; and
receiving a portion of the return in accordance with a sharing ratio for a tax-advantaged period of the fund.

30. The method of claim 28 comprising:
providing a debt component to the tax-advantaged investment fund for investing in said plurality of wind energy projects; and
receiving repayment of said debt component from cash flow generated by the plurality of wind energy projects and/or the capital of the fund based on a dual tranche structure.
